(19) United States
(12) Patent Application Publication
(10) Pub. No.: US 2016/0148323 A1
(43) Pub. Date: May 26, 2016

(54) SYSTEM AND METHOD FOR CREDITING USERS RESPECTIVE OF A VALUE-ADDED TAX RECLAIM

(71) Applicant: Vatbox, Ltd., Herzliya (IL)

(72) Inventors: Noam GUZMAN, Ramat Hasharon (IL); Isaac SAFT, Kfar Neter (IL)

(73) Assignee: Vatbox, Ltd., Herzliya (IL)

(21) Appl. No.: 15/012,382

(22) Filed: Feb. 1, 2016

Related U.S. Application Data
(63) Continuation of application No. PCT/US2014/049164, filed on Jul. 31, 2014.
(60) Provisional application No. 61/861,440, filed on Aug. 2, 2013.

(51) Int. Cl. G06Q 40/00

(52) U.S. Cl. CPC G06Q 40/123

(57) ABSTRACT

A system and method for crediting users respective of a VAT reclaim are provided. The method includes receiving a notification of at least a partially successful VAT reclaim respective of a user request for a VAT reclaim; analyzing at least a VAT receipt respective of the at least partially successful VAT reclaim; determining a number of newly accumulated credit points respective of the at least VAT receipt; and adding the number of newly accumulated credit points to a number of previously credit points to yield a new total number of credit points.

### CROSS-REFERENCE TO RELATED APPLICATIONS

This application is a continuation of PCT application No. PCT/US2014/049164, filed on Jul. 31, 2014, which claims the benefit of U.S. Provisional Application No. 61/861,440 filed on Aug. 2, 2013, the contents of which are hereby incorporated by reference.

### TECHNICAL FIELD

The present invention relates generally to value-added tax (VAT) refunding platforms and, more specifically, to providing incentives for users to use VAT refunding platforms.

### BACKGROUND

The Value Added Tax, or VAT, is a broadly based consumer tax assessed on the value added to goods and services. It applies more or less to all goods and services that are bought and sold for use or consumption in a community. It should be noted that, even when a person can claim a refund of a VAT, the person is nevertheless required to pay the VAT at the point of purchase and subsequently reclaim the VAT paid retroactively.

The laws and regulations of many countries allow foreign travelers the right for reimbursement or a refund of certain taxes such as, e.g., VATs paid for goods and/or services abroad. As such, laws and regulations are different from one country to another, and determination of the actual VAT refunds that one is entitled to receive often requires that the seeker of the refund possess a vast amount of knowledge in the area of tax laws abroad. As a result, such foreign travelers may not feel incentivized to seek VAT refunds, as the refunds may appear to be out of reach or otherwise not worthwhile.

With respect to potentially large refunds, properly managed VAT refunding platforms may be crucial for saving money. As an example, VAT refunding platforms may be particularly important to large enterprises which require many employees to travel for work purposes. When employees are not given incentives for ensuring or contributing to successful VAT refunds, such employees are much less likely to successfully complete such refunds.

It would therefore be advantageous to provide a solution that would overcome the deficiencies of the prior art by providing incentives for effectively completing VAT refunds and yielding successful VAT reclaims.

### SUMMARY

Certain exemplary embodiments disclosed herein include a method for computerized method for crediting a user respective of a value-added tax (VAT) reclaim. The method comprises receiving a notification of at least a partially successful VAT reclaim respective of a user request for a VAT reclaim; analyzing at least a VAT receipt respective of the at least partially successful VAT reclaim; determining a number of newly accumulated credit points respective of the at least VAT receipt; and adding the number of newly accumulated credit points to a number of previously credit points to yield a new total number of credit points.

Certain exemplary embodiments disclosed herein include a system for crediting a user respective of a value-added tax (VAT) reclaim. The system comprises a processor; and a memory communicatively connected to the processor, the memory containing instructions that, when executed by the processor, configure the system to:

receive a notification of at least a partially successful VAT reclaim respective of a user request for a VAT reclaim; analyze at least a VAT receipt respective of the at least partially successful VAT reclaim; determine a number of newly accumulated credit points respective of the at least VAT receipt; and add the number of newly accumulated credit points to a number of previously credit points to yield a new total number of accumulated points.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a value-added tax (VAT) reclaim system configured according to an embodiment;

FIG. 2 is a flowchart illustrating the processing of a potential VAT reclaim according to an embodiment;

FIG. 3 is a flowchart illustrating prediction of a potential VAT reclaim success according to an embodiment;

FIG. 4 is a flowchart illustrating crediting users based on successful VAT reclaims according to an embodiment;

FIG. 5 is a flowchart illustrating generation of a real-time estimation of a potential number of credit points that may be accumulated respective of at least partially successful VAT reclaim according to and embodiment;

FIG. 6 is a flowchart illustrating authentication of a VAT receipt according to an embodiment; and

FIG. 7 is a flowchart illustrating determination of eligibility of a VAT receipt according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for crediting users respective of a VAT reclaim. A notification respective of at least a partially successful VAT reclaim is received. At least one VAT receipt respective of the at least a partially successful VAT reclaim and of a user requesting the VAT reclaim is analyzed. A number of newly accumulated credit points respective of the VAT reclaim success may be determined. In some embodiments, upon receiving one or more parameters respective of a VAT reclaim, an estimation of the potential number of newly accumulated credit points which will be accumulated may be generated in real-time.

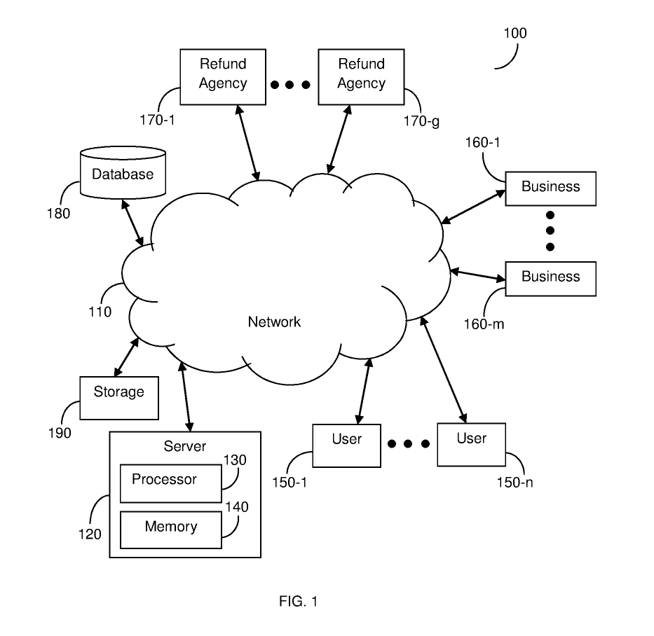

FIG. 1 shows an exemplary and non-limiting schematic diagram of a VAT reclaim system 100 configured according to an embodiment. A network 110 is coupled to several components of the system 100. The network 110 may be, but is not limited to, a local area network (LAN), a wide area network (WAN), a metro area network (MAN), the worldwide web (WWW), the Internet, implemented as wired and/or wireless networks, and any combinations thereof. A server 120 is communicatively connected to the network 110. The server 120 includes a processor 130 and a memory 140 that contains instructions which may be executed by the processor 130. The system 100 includes one or more user nodes 150-1 through 150-n (hereinafter referred to individually as a user note 150 and collectively as user nodes 150, merely for simplicity purposes), that are also communicatively connected to the network 110.

The system 100 optionally includes one or more business nodes 160-1 through 160-m (hereinafter referred to individually as a business node 160 and collectively as business nodes 160, merely for simplicity purposes) that are communicatively connected to the server 120 via the network 110. A business operating a business node 160 may be, but is not limited to, a hotel, a shop, a service provider, and so on. One or more refund agency nodes (RANs) 170-1 through 170-g (hereinafter referred to individually as a RAN 170 and collectively as RANs 170, merely for simplicity purposes) may also be communicatively connected to the server 120 via the network 110. An agent operating a RAN 170 may be, but is not limited to, a tax authority, an accountant, and so on. Each one of the nodes, including the user nodes 150, the business nodes 160, and the RANs 170 may be, but is not limited to, a personal computer (PC), a notebook computer, a cellular phone, a smartphone, a tablet device, and the like.

The system 100 typically includes a database 180 communicatively connected to the memory 140. The server 120 may be configured to store in the database 180 information respective of, but not limited to, a user, one or more VAT receipts, one or more parameters related to purchases of goods, one or more parameters related to purchases of services, one or more parameters related to businesses providing the goods or services, conditions respective of laws related to VAT refunds in a variety of countries, and so on. The conditions respective of laws related to VAT refunds may include, but are not limited to, a minimum purchase required, a list of businesses in which a VAT refund is possible, an obligation to disclose all information needed respective of goods that are mentioned in the VAT receipt, an obligation to disclose all information needed respective of a user who submitted the VAT receipt, whether the potential VAT reclaim may be dependent on a non-commercial purchase of goods, and so on.

According to one embodiment, the information stored in the database 180 may be received from external sources. Such external sources may be, but are not limited to, one or more user nodes 150 or one or more business node 160. The system may also include a storage 190 for storing numbers of users' credit points. It should be noted that the storage 190 may be part of the memory 140, or separate entity communicatively connected to the server 120.

According to one embodiment, upon analyzing a VAT receipt, the number of newly accumulated credit points determined respective thereof is added to a number of previously stored credit points stored in the storage 190, and the sum is stored as a new total number of credit points. In a further embodiment, after each accumulation of credit points is complete, the number of previously stored credit points may be set equal to the most recently stored new total number of credit points.

According to one embodiment, the server 120 is configured to receive a notification respective of at least a partially successful VAT reclaim from the VAT reclaim system 100. Upon analyzing at least one VAT receipt respective of the partially successful VAT reclaim, the server 120 may be configured to determine a number of newly accumulated credit points to be provided to a user. In an embodiment, such accumulation may be reported to the business via, e.g., a business node 160.

In another embodiment, previously stored credit points may be redeemed by the user to purchase goods and/or services, or may be redeemed as discounts for purchasing goods and/or services. The values and/or distribution of the credit points may differ among businesses and/or based on the service providers who sold the goods and/or services. Service providers are entities which sell goods and/or services to employees of businesses while such employees are traveling.

As a non-limiting example of newly accumulated credit points, a business may provide one newly accumulated credit point for every dollar successfully reclaimed via a VAT reclaim. As another non-limiting example, a business may provide one hundred newly accumulated credit points to its employees for every successful VAT reclaim, regardless of how much money was reclaimed.

A business may prefer that its employees purchase goods and services from some service providers rather than from other service providers. As a non-limiting example, a business may prefer that its employees use a particular airline company for international flights. In such an example, VAT reclaims related to that particular airline company may yield more newly accumulated credit points for employees than similarly priced expenses related to other airline companies.

In an embodiment, when a user redeems his or her stored credit points for goods, services, and/or discounts, the number of redeemed points may be subtracted from the number of previously stored credit points to obtain a new total number of credit points. In a further embodiment, after each redemption of credit points, the number of previously stored credit points may be set equal to the most recently stored new total number of credit points.

As a non-limiting example of accumulation and redemption of credit points, a business chooses to provide one newly accumulated credit point to its employees for each dollar of VAT reclaimed by each respective employee. In this example, a user obtains a VAT reclaim for the business of $200, thereby obtaining 200 newly accumulated credit points. If the user had 100 previously stored credit points, the user's new total number of credit points would be 300 points. Thus, upon completion of accumulation, the user's number of previously stored credit points would be set equal to 300 points. The user may choose to redeem his or her stored points to obtain at least one of: a hat, a watch, and a coat. In this example, the hat is valued at 30 points, the watch is valued at 100 points, and the coat is valued at 150 points. If the user chooses to redeem his or her previously stored credit points for one each of the hat, the watch, and the coat, the user's new credit point total would be 20 points. Upon completion of redemption, the user's number of previously stored credit points would be set equal to 20 points.

If the user of the previous example instead chose to redeem credit points for two watches and no other goods, the user's new credit point total would be 100 points. In that scenario, upon completion of redemption, the user's number of previously stored credit points would be set equal to 100 points.

The analysis of the at least one VAT receipt typically includes retrieving from the database 180 information respective of a user requesting the VAT reclaim. Such information may be, but is not limited to, the user residency, one or more parameters related to the user eligibility for a VAT refund, and so on. According to another embodiment, the server 120 is configured to predict a potential number of newly accumulated credit points that may be accumulated respective of a potential VAT reclaim. The request may be received, for example, from a user together with at least one parameter respective of the potential VAT reclaim.

As a non-limiting example, a user provides information regarding himself or herself, a purchase of goods abroad, and a VAT receipt via a user node 150. The server 120 receives this information over the network 110 and stores it in database 180. The server analyzes the information to determine refund potential and provides the information to a RAN 170. A refund agency may confirm the reclaims success or partial success respective of the provided information. Respective of the analysis and/or confirmation, a number of newly accumulated credit points provided to the user due to this transaction may be determined and added to the number of previously stored credit points in the storage 190. Such determination and accumulation may be reported to the business via, e.g., business node 160.

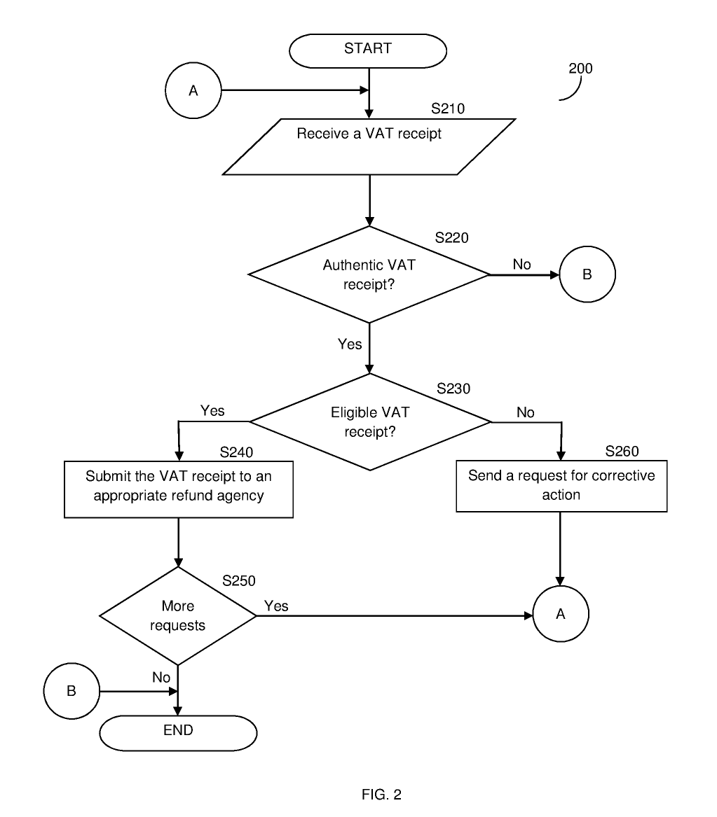

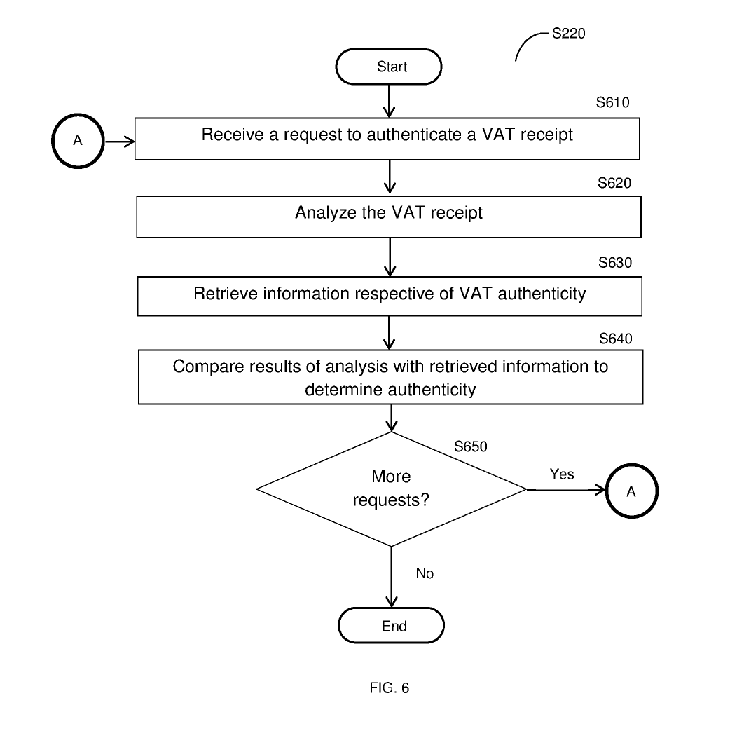

FIG. 2 is an exemplary and non-limiting flowchart 200 illustrating a method for VAT reclaim processing according to an embodiment. In S210, at least one VAT receipt is received. According to an embodiment, the VAT receipt may be provided by a business node 160 or a user node 150, or the VAT receipt may be retrieved from a database 180. In S220, it is checked whether the VAT receipt is an authentic VAT receipt and, if so, execution continues with S230; otherwise, execution terminates. The check may be made respective of information stored in a database (e.g., the database 180). Authentication checking is described further herein below with respect to FIG. 6.

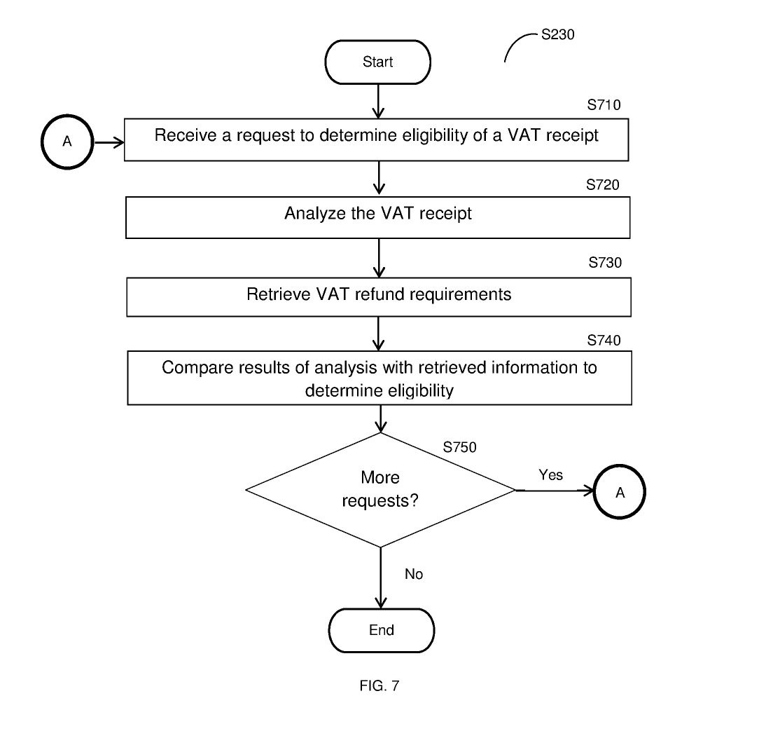

In S230, it is checked whether the VAT receipt is an eligible VAT receipt and, if so, execution continues with S240; otherwise, execution continues with S260. According to one embodiment, one or more parameters that are found in the VAT receipt which may be required for a VAT refund are analyzed. Further, one or more missing, unclear or otherwise unacceptable parameters may be identified. Eligibility checking of VAT receipts is described further herein below with respect to FIG. 7.

In S240, the VAT receipt is sent to an appropriate or otherwise preferred refund agency. In an embodiment, the VAT receipt may be sent to the refund agency via a RAN 170. The preference may be determined based on, but not limited to, the agency's effectiveness in getting refunds, the agency's location, and so on. As a non-limiting example, a VAT agency may be determined as appropriate if the agency is the nearest VAT agency to the user's residency and/or current location.

In S250, it is checked whether there are additional requests to reclaim VAT receipts and, if so, execution continues with S210; otherwise, execution terminates. In S260, upon identification of an ineligible VAT receipt, a request to edit the VAT receipt is sent. In an embodiment, the request may be sent to a user node 150 or a business node 160 that provided the VAT reclaim. After the VAT receipt is edited, execution continues with S210.

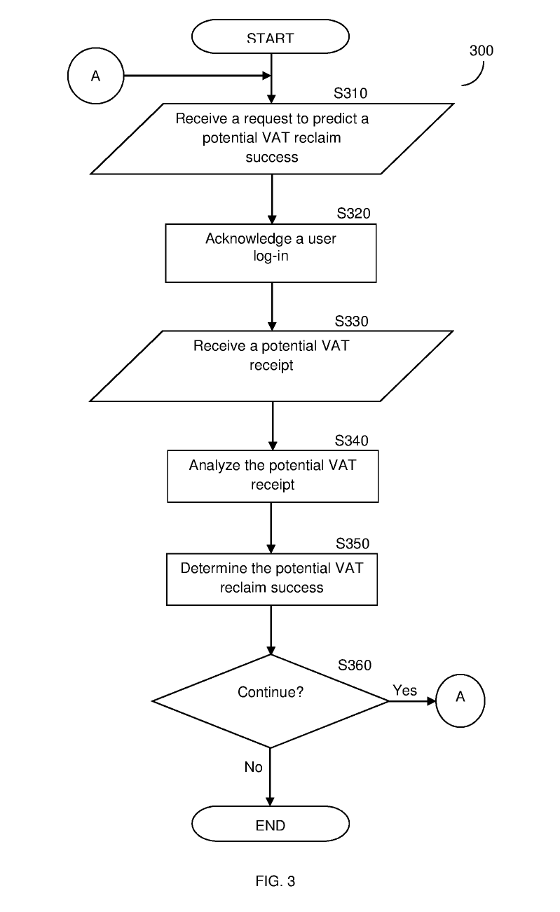

FIG. 3 depicts an exemplary and non-limiting flowchart 300 for predicting a success of a potential VAT reclaim according to one embodiment. In S310, a request to predict the success of a potential VAT reclaim is received. In S320, a user log-in is acknowledged. In an embodiment, such log-in may be performed via a user node (e.g., a user node 150).

As a non-limiting example of a user log-in, a business sets up a secure VAT reclaim system which employees may access by entering their employee identification numbers and a password. Upon correct input of the identification number and password, the user log-in is acknowledged and the user may proceed with seeking the potential reclaim success.

In S330, a potential VAT receipt is retrieved. In another embodiment, the potential VAT receipt may be retrieved from a database (e.g., the database 180). In S340, the VAT receipt is analyzed. According to one embodiment, a target country in which the potential VAT reclaim is processed may be identified. According to another embodiment, it is determined whether the VAT receipt complies with laws in the target country. It may be further determined whether the VAT receipt does not support one or more conditions required in order to receive the VAT refund in the target country. Such identification will naturally reduce the chances for the potential VAT reclaim.

According to this embodiment, the user eligibility for the VAT refund is determined respective of, for example, a purchase type for which the VAT refund has been requested. It is determined whether the purchase type is a type of business expenditure included in the list of business expenditures for which the VAT refund is possible. Moreover, it is checked whether the minimum purchase as it is recorded in the VAT receipt is suitable. Further, it is checked whether the good or service was commercially purchased. Such check may be performed by identifying a record of a sum of the cost of goods listed on the VAT receipt and/or an amount of goods that are listed in the VAT receipt.

According to yet another embodiment, one or more errors in the Vat receipt may be identified. An error may be, but is not limited to, missing or partial information, unclear information, a combination thereof, and so on. Such error may occur when information respective of the user who submitted the VAT receipt and/or information respective of goods mentioned in the VAT receipt are not disclosed appropriately. Identification of one or more errors will naturally reduce the chances for the potential VAT reclaim. In such case, a request for corrective action to produce a qualified VAT receipt and to increase the success rate, as described in greater details herein above with respect to FIG. 2, may be sent. Additionally, some countries demand an original VAT receipt for any VAT reclaims. For reclaims from such countries, failure to identify an original VAT receipt will reduce the chance of a successful VAT reclaim.

In S350, the potential VAT reclaim success is determined respective of the VAT receipt analysis and any retrieved information. In S360, it is checked whether there are additional requests to predict reclaim success and, if so, execution continues with S310; otherwise, execution terminates.

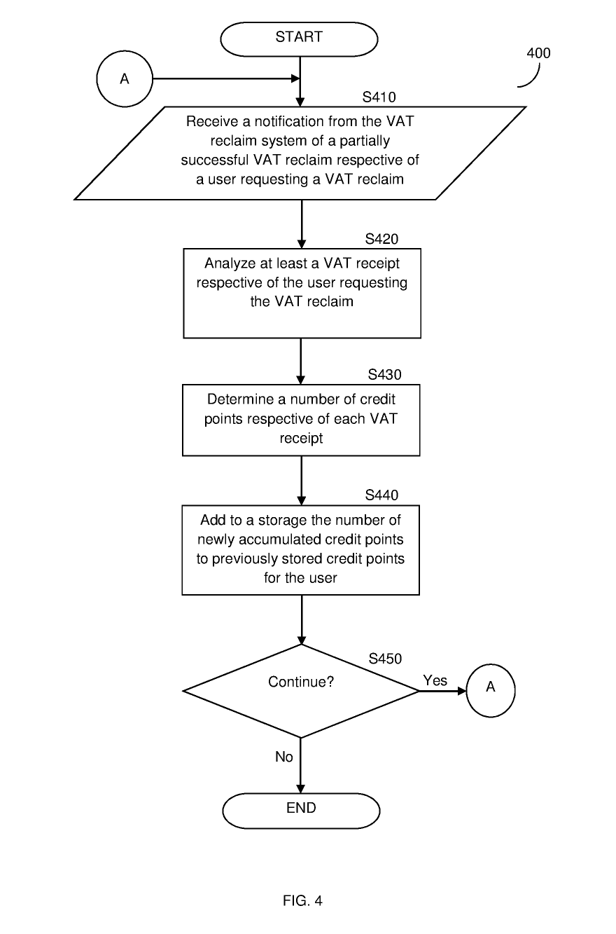

FIG. 4 is an exemplary and non-limiting flowchart 400 illustrating a method for crediting users based on VAT reclaims according to an embodiment. In S410, a notification of at least a partially successful VAT reclaim respective of a user requesting a VAT reclaim is received. In S420, at least a VAT receipt respective of the at least a partially successful VAT reclaim and information received respective thereto is analyzed. In an embodiment, such information may be retrieved from a database (e.g., the database 180). According to one embodiment, the analysis may include prioritizing the purchase of a particular product or service over another purchase, as further described herein below.

The analysis performed in S420 may also be performed respective of information retrieved or received respective of a user. Such information may include, but is not limited to, user residency, one or more parameters related to user eligibility for VAT refunds, and so on. According to an embodiment, the VAT receipt may be further analyzed using, for example, optical character recognition OCR techniques to identify, for example, the place of purchase, the type of good or service purchased, the price paid for goods and services, the price paid for each good or service, the type of entity from which the good or service was purchased, and so on. In that embodiment, further analysis may be utilized to determine the number of credit points the user has accumulated respective of the successful VAT transaction. As a non-limiting example, a user's purchase of a bus ticket and subsequent VAT reclaim thereof may generate more credit points than a user's purchase of a train ticket and corresponding VAT reclaim.

In S430, the number of newly accumulated credit points obtained by the user pursuant to the instant VAT transaction based on received information and the analysis made respective thereof is determined. In S450, the number of newly accumulated credit points may be added to a number of previously stored credit points for the user. In an embodiment, such credit points may be stored in a storage (e.g., the storage 190). In S460, it is checked whether there are additional notifications and, if so, execution continues with S410; otherwise, execution terminates.

As a non-limiting example, a user requests a VAT reclaim and a notification that the requested reclaim is at least partially successful is retrieved. Respective of the notification a VAT receipt containing information about the original transaction that may be eligible for a Vat refund is analyzed. Based on the analysis, it is determined that the user properly sought one reclaim for $500 worth of VAT refund-eligible goods and services. In this example, the user's employer provides 200 credit points per reclaim, regardless of the value of the reclaim. Thus, based on the user's sole reclaim, it is determined that the user is entitled to 200 newly accumulated credit points. In this example, the user does not have any previously stored credit points. Thus, the 200 newly accumulated credit points are stored and added to the 0 previously stored credit points. The user has not submitted any additional receipts, so execution terminates.

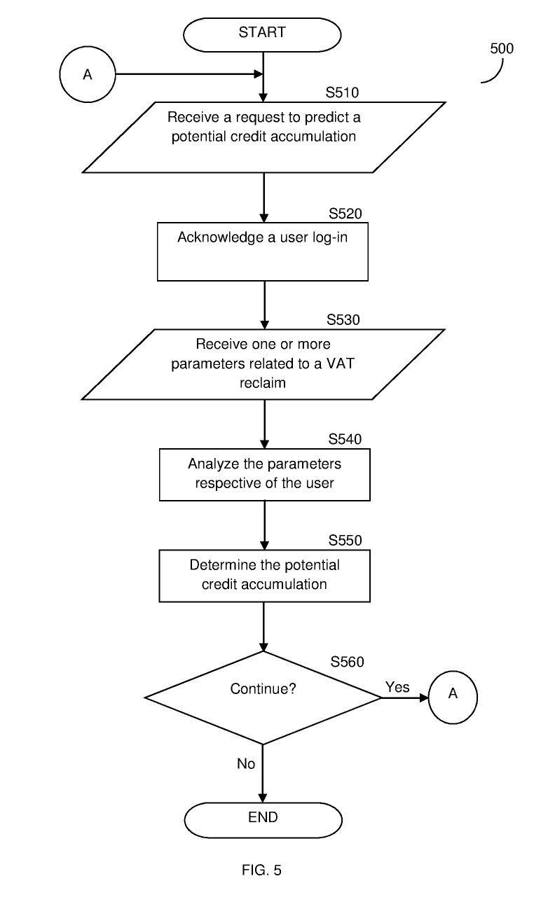

FIG. 5 is an exemplary and non-limiting flowchart 500 depicting generation of real-time estimation of a potential number of newly accumulated credit points respective of a potential VAT reclaim according to one embodiment. In S510, a request to predict the potential number of newly accumulated credits respective of a potential VAT reclaim in a case of at least a partially successful VAT reclaim is received. The request may be received from, for example, a user node (e.g., the user node 150).

In S520, a user log-in is acknowledged. In an embodiment, such an acknowledgment may be made via identification of a user via one or more log-in credentials such as, but not limited to, a username, a password, an electronic key, and so on.

As a non-limiting example of a user log-in, a business sets up a secure VAT reclaim system which employees may access by entering their employee identification numbers and a password. Upon correct input of the identification number and password, the user log-in is acknowledged and the user may proceed with seeking the potential credit accumulation estimation.

In S530, the one or more parameters related to the potential VAT reclaim are received. Such parameter(s) may be, but are not limited to, a place of purchase, a type of product purchased, a price of purchase, a type of business in which a product is purchased, and so on.

In S540, the server 120 analyzes the parameter(s) respective of the user and the framework in which the user wishes to receive the VAT refund. Such analysis is typically performed based on information stored in a database (e.g., the database 180). Such information may be, but is not limited to, the user residency, one or more parameters related to the user eligibility for VAT reclaim, information respective of at least one country where a potential VAT reclaim may be issued, one or more parameters related to a type of purchases of goods and/or services, etc. According to one embodiment, such information may be received as an input from a user. According to another embodiment, the user eligibility for a VAT refund may be determined respective of, for example, the type of product/service purchased, as described in greater detail herein above with respect of FIG. 2.

In S550, the potential number of newly accumulated credit points respective of the potential VAT reclaim is determined in real-time. According to an embodiment, a user may receive a notification respective of this potential number of newly accumulated credit points. In S560, it is checked whether there are additional requests to estimate a potential number of newly accumulated credit points respective of a potential Vat reclaim and, if so, execution continues with S510; otherwise, execution terminates.

FIG. 6 is a flowchart S220 illustrating authentication checking according to an embodiment. In S610, a request to authenticate a VAT receipt is received. In S620, the VAT receipt is analyzed to determine receipt information that may be pertinent to authenticity. Analysis of a VAT receipt may include, but is not limited to, scanning the receipt, determining information contained in the VAT receipt based on digital image and/or word recognition, receiving information from a user or business, and so on. Information that is pertinent to authenticity may be, but is not limited to, items sold, invoice designation of items, store name, store address, and the like.

In S630, information pertinent to VAT authenticity checking is retrieved. In an embodiment, such information may be retrieved from a database (e.g., database 180). Information that is pertinent to authenticity checking may include, but is not limited to, statutory formal requirements and classifications of goods and/or services. Classifications of goods and/or may be utilized, for example, to determine if the information analyzed from the VAT receipt with respect to specific goods and/or services sold generally reflects the type of invoice.

In S640, the results of the analysis are compared with the retrieved information to determine authenticity. If the information matches or is otherwise sufficiently matching, the receipt may be determined as authentic. Sufficiency of matching may be predefined by, e.g., a refund agency. In S650, it is checked whether more requests have been received. If so, execution continues with S610. Otherwise, execution terminates.

As a non-limiting example, a VAT receipt is received. The VAT receipt is analyzed and it is determined that the VAT receipt indicates a purchase of a book. In this example, books do not qualify for VAT refunds since they are not subject to VATs. Information indicating either that the store that sold the book or the invoice itself deals with electronics, and not books, is retrieved. Upon comparing the result of the analysis with the results of the retrieval, it is determined that the category of the good (book) does not match the category of the invoice (electronics). As a result, the receipt is found to be unauthentic.

FIG. 7 is an exemplary and non-limiting flowchart S230 illustrating eligibility checking according to an embodiment. In S710, a request to determine eligibility of a VAT receipt is received. In S720, the VAT receipt is analyzed to determine receipt information that may be pertinent to eligibility. Analysis of a VAT receipt may include, but is not limited to, scanning the receipt, determining information contained in the VAT receipt based on digital image and/or word recognition, receiving information from a user or business, etc. Information pertinent to eligibility may include, but is not limited to, types of items sold, price of each item, total price of items, location of business, date of purchase, and the like.

In S730, VAT refund requirements are retrieved. In an embodiment, these requirements may be retrieved from a database (e.g., database 180) being pre-populated with such requirements. VAT refund requirements may include, but are not limited to, inclusion in an eligible category of goods, minimum required purchase total, time period for eligibility, and the like.

In S740, the results of the analysis are compared to the results of the retrieval to determine whether the receipt is eligible for a VAT refund. If the information matches or is otherwise sufficiently matching, the receipt may be determined as eligible for a VAT refund. Sufficiency of matching may be predefined by, e.g., a refund agency. In S750, it is checked whether additional requests have been received. If so, execution continues with S710. Otherwise, execution terminates.

As a non-limiting example, a VAT receipt is received. The receipt is analyzed and it is determined that the receipt indicates a purchase of a book. Information regarding classifications of goods and services that do not qualify for a VAT refund is retrieved. This classification information indicates that books do not qualify for the VAT refund. Upon comparing the result of the analysis with the results of the retrieval, it is determined that the receipt for purchase of a book is ineligible for a VAT refund.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for automatically authenticating digital documents for crediting a user for a required activity, comprising:
receiving a notification of at least a partially successful activity associated with the required activity;
analyzing an activity file related to the at least a partially successful activity, wherein analyzing the activity file includes digital image recognition of the activity file;
retrieving authenticity checking data for the at least a partially successful activity;
comparing the authenticity checking data to results of the analysis to determine whether the activity file is authentic;
determining a number of newly accumulated points based on the analysis, when the activity file is authentic; and
adding the number of newly accumulated points to a number of previously accumulated points to generate a new total number of points for crediting the user.

2. The method of claim 1, further comprising:
generating a notification indicating the credit and including the new total number of points.

3. The method of claim 1, wherein the activity file is retrieved from at least one of: a database, and a user node.

4. The method of claim 3, further comprising:
analyzing the activity file based on user information of the user, wherein the user information includes at least one of: the user's residency, and at least one parameter related to eligibility of the user for succeeding in the activity.

5. The method of claim 4, further comprising:
generating a real-time estimation of a potential number of newly accumulated points based on the at least one eligibility parameter.

6. The method of claim 5, wherein the at least one eligibility parameter is at least one of: a location of the activity, and a participating entity.

7. The method of claim 1, wherein the authenticity checking data includes at least one of: a product classification, and a statutory requirement.

8. The method of claim 7, wherein comparing the authenticity checking data to results of the analysis to determine whether the activity file is authentic further comprises:
determining whether the authenticity checking data matches the analysis results above a predetermined threshold; and
determining that the activity file is authentic when the matching is above the predetermined threshold.

9. The method of claim 1, wherein the activity file is at least a receipt indicating a refundable amount.

10. A non-transitory computer readable medium having stored thereon instructions for causing one or more processing units to execute the method according to claim 1.

11. A system for automatically authenticating digital documents for crediting a user for a required activity, comprising:
a processing unit; and
a memory coupled to the processing unit, the memory containing instructions that, when executed by the processing unit, configure the system to:
receive a notification of at least a partially successful activity associated with the required activity;
analyze an activity file related to the at least a partially successful activity, wherein analyzing the activity file includes digital image recognition of the activity file;
retrieve authenticity checking data for the at least a partially successful activity;
compare the authenticity checking data to results of the analysis to determine whether the activity file is authentic;
determine a number of newly accumulated points based on the analysis, when the activity file is authentic; and
add the number of newly accumulated points to a number of previously accumulated points to generate a new total number of points for crediting the user.

12. The system of claim 11, wherein the system is further configured to:
generate a notification indicating the credit and including the new total number of points.

13. The system of claim 11, wherein the activity file is retrieved from at least one of:
a database, and a user node.

14. The system of claim 13, wherein the system is further configured to:
analyze the activity file based on user information of the user, wherein the user information includes at least one of: the user's residency, and at least one parameter related to eligibility of the user for succeeding in the activity.

15. The system of claim 14, wherein the system is further configured to:
generate a real-time estimation of a potential number of newly accumulated points based on the at least one eligibility parameter.

16. The system of claim 15, wherein the at least one eligibility parameter is at least one of: a location of the activity, and a participating entity.

17. The system of claim 11, wherein the authenticity checking data includes at least one of: a product classification, and a statutory requirement.

18. The system of claim 17, wherein comparing the authenticity checking data to results of the analysis to determine whether the activity file is authentic further comprises:
determine whether the authenticity checking data matches the analysis results above a predetermined threshold; and
determine that the activity file is authentic when the matching is above the predetermined threshold.

19. The system of claim 11, wherein the activity file is at least a receipt indicating a refundable amount.
